(19) United States
(12) Patent Application Publication
(10) Pub. No.: US 2012/0322014 A1
(43) Pub. Date: Dec. 20, 2012

(54) APPARATUS AND METHOD FOR TREATING A SUBSTRATE

(76) Inventor: HOONSOUNG JOO, Asan-si (KR)

(21) Appl. No.: 13/474,964

(22) Filed: May 18, 2012

(30) Foreign Application Priority Data
Jun. 14, 2011 (KR) 10-2011-0057431

(51) Int. Cl. F27B 9/30; F27B 9/24

(52) U.S. Cl. 432/1; 432/122

(57) ABSTRACT

An apparatus for treating a substrate includes a heating member including a heating block, a front rail disposed at a first side of the heating block and configured to support a first edge of the substrate, a rear rail disposed at a second side of the heating block, opposing the first side, and a rail driver configured to move at least one of the front rail and the rear rail. The heating block is configured to receive and heat the substrate, the rear rail is substantially parallel with the front rail and is configured to support a second edge of the substrate, and a distance between the front rail and the rear rail is adjusted to be substantially equal to a width of the substrate.

### CROSS-REFERENCE TO RELATED APPLICATIONS

This application claims priority under 35 U.S.C. §119 to Korean Patent Application No. 10-2011-0057431, filed on Jun. 14, 2011, the disclosure of which is incorporated by reference herein in its entirety.

### TECHNICAL FIELD

The present inventive concept relates to an apparatus and method for fabricating a semiconductor package and, more particularly, to an apparatus and method for treating a substrate.

### DISCUSSION OF THE RELATED ART

Semiconductor packages are fabricated using various assembly processes. For example, a die sawing process, a die bonding process, a wire bonding process, a molding process and a marking process are processes that are commonly used when fabricating semiconductor packages.

During the wire bonding process, pads of a semiconductor chip and leads of a lead frame disposed on a substrate are connected by bonding wires. The semiconductor chip may be mounted on the lead frame prior to the wire bonding process. The wire bonding process may be performed on substrates having different sizes.

### SUMMARY

Exemplary embodiments of the inventive concept are directed to an apparatus and a method for treating a substrate.

In an exemplary embodiment, an apparatus for treating a substrate includes a heating member including a heating block on which the substrate is located and heated, a front rail disposed at one side of the heating block to support one edge of the substrate, a rear rail parallel with the front rail and configured to support the other edge of the substrate, and a rail driver moving the front rail to adjust a distance between the front rail and the rear rail to a width of the substrate.

In an exemplary embodiment, a method of treating a substrate includes at least one of a first process of treating a first substrate and a second process of treating a second substrate having a narrower width than the first substrate. The first process includes moving at least one of a front rail and a rear rail parallel with each other to adjust a distance between the front rail and the rear rail to a width of the first substrate, transferring the first substrate into a space between the front rail and the rear rail, and heating the first substrate using a heating block. The second process includes moving at least one of the front rail and the rear rail parallel with each other to adjust the distance between the front rail and the rear rail to a width of the second substrate, transferring the second substrate into a space between the front rail and the rear rail, and heating the second substrate using the heating block.

In an exemplary embodiment, an apparatus for treating a substrate includes a heating member including a heating block, a front rail disposed at a first side of the heating block and configured to support a first edge of the substrate, a rear rail disposed at a second side of the heating block, opposing the first side, and a rail driver configured to move at least one of the front rail and the rear rail. The heating block is configured to receive and heat the substrate, the rear rail is substantially parallel with the front rail and is configured to support a second edge of the substrate, and a distance between the front rail and the rear rail is adjusted to be substantially equal to a width of the substrate.

In an exemplary embodiment, a method of treating a first substrate and a second substrate includes adjusting a distance between a front rail of an apparatus and a rear rail of the apparatus to be substantially equal to a width of the first substrate, transferring the first substrate into a space between the front rail and the rear rail while the distance is substantially equal to the width of the first substrate, heating the first substrate while the first substrate is in the space, adjusting the distance to be substantially equal to a width of the second substrate, transferring the second substrate into the space while the distance is substantially equal to the width of the second substrate, and heating the second substrate while the second substrate is in the space. The width of the second substrate is less than the width of the first substrate, and the front rail and the rear rail are substantially parallel with each other.

In an exemplary embodiment, a method of treating a substrate includes adjusting a distance between a front rail of an apparatus and a rear rail of the apparatus to be substantially equal to a width of the substrate, transferring the substrate into a space between the front rail and the rear rail, and heating the substrate using a heating block of the apparatus. The front rail and the rear rail are substantially parallel with each other, and an edge of the heating block is permitted to pass through an opening disposed in at least one of the front rail and the rear rail while the distance is adjusted.

### BRIEF DESCRIPTION OF THE DRAWINGS

The above and other features of the inventive concept will become more apparent by describing in detail exemplary embodiments thereof with reference to the accompanying drawings, in which:

FIG. 1 is a perspective view illustrating an apparatus for treating a substrate, according to an exemplary embodiment;

FIG. 2 is a perspective view illustrating a front rail and a heating member of FIG. 1, according to an exemplary embodiment;

FIG. 3 is a vertical cross-sectional view taken along line A-A′ of FIG. 1, according to an exemplary embodiment;

FIG. 4 is a plan view illustrating a method of treating a first substrate, according to an exemplary embodiment;

FIG. 5 is a vertical cross-sectional view taken along line A-A′ of FIG. 4;

FIG. 6 is a plan view illustrating a method of treating a second substrate, according to an exemplary embodiment;

FIG. 7 is a cross-sectional view illustrating an apparatus including a heating member coupled with a guide block, according to an exemplary embodiment;

FIG. 8 is a cross-sectional view illustrating an apparatus including a heating member coupled with a guide block, according to an exemplary embodiment;

FIG. 9 is a perspective view illustrating an apparatus for treating a substrate, according to an exemplary embodiment;

FIG. 10 is a plan view illustrating a method of treating a first substrate using the apparatus shown in FIG. 9, according to an exemplary embodiment; and

FIG. 11 is a plan view illustrating a method of treating a second substrate using the apparatus shown in FIG. 9, according to an exemplary embodiment.

### DETAILED DESCRIPTION OF THE EXEMPLARY EMBODIMENTS

Exemplary embodiments of the inventive concept are described below with reference to the accompanying drawings. Like reference numerals may refer to like elements throughout the accompanying drawings.

It will be understood that when an element is referred to as being “connected” or “coupled” to another element, it may be directly connected or coupled to the other element or intervening elements may be present.

Similarly, it will be understood that when an element such as a layer, region or substrate is referred to as being “on,” “over,” “under” or “below” another element, it can be directly on, over, under or below the other element or intervening elements may be present. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be also understood that although the terms first, second, third, etc. may be used herein to describe various elements, these elements should not be limited by these terms. These terms are only used to distinguish one element from another element. Thus, a first element in some exemplary embodiments could be termed a second element in other exemplary embodiments without departing from the teachings of the present inventive concept.

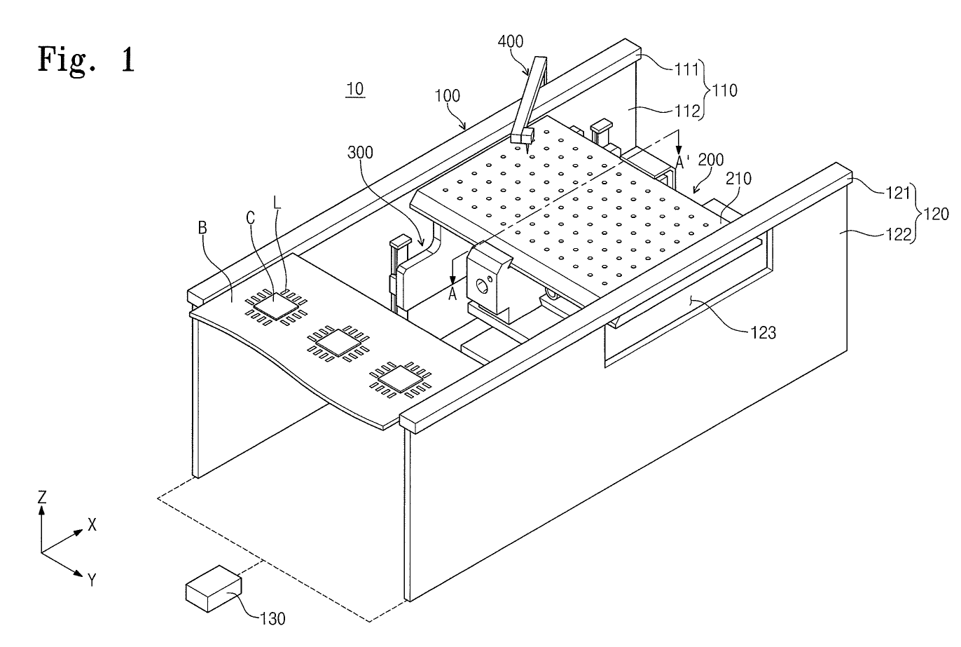

FIG. 1 is a perspective view illustrating an apparatus for treating a substrate, according to an exemplary embodiment.

Referring to FIG. 1, an apparatus 10 for treating a substrate is configured to perform a wire bonding process. The wire bonding process may connect leads L of lead frames disposed on a substrate B and semiconductor chips C mounted on the lead frames by bonding wires. The substrate B may include a printed circuit board (PCB). In an exemplary embodiment, the apparatus 10 includes a rail member 100, a heating member 200, a connecting member 300 and a wire bonding member 400. The rail member 100 may guide the substrate B to a certain position. for example, the substrate B may move substantially in a straight line along the rail member 100. The heating member 200 may heat the semiconductor chip C and the leads L to a predetermined temperature. The connection member 300 connects the rail member 100 to the heating member 200. The wire bonding member 400 connects the semiconductor chips C and the leads L of the lead frames by wires. Hereinafter, a direction in which the substrate B moves along the rail member 100 will be referred to as a first direction extending along an x-axis, and a direction substantially perpendicular to the first direction will be referred to as a second direction extending along a y-axis when viewed from a top plan view. Further, a direction substantially perpendicular to both the first and second directions will be referred to as a third direction extending along a z-axis.

In an exemplary embodiment, the rail member 100 guides the substrate B in the first direction. The substrate B may be provided from a separate substrate supplier. Before the substrate B is supplied to the rail member 100, at least one lead frame may be disposed on the substrate B and the semiconductor chips C may be mounted on the lead frames. Therefore, the substrate B, including the lead frames and the semiconductor chips C, moves along the rail member 100. The rail member 100 may include a front rail 110, a rear rail 120 and a rail driver 130.

In an exemplary embodiment, the front rail 110 is disposed along the first direction and may support a first side of the substrate B. The front rail 110 includes a first rail 111 and a first rail supporting block 112. The first rail 111 may have a long plate shape extending in the first direction. The first rail 111 may be located at the same level as the substrate B. For example, the substrate B may be transferred along the rail member 100, and the first rail 111 may guide the first side of the substrate B. The first rail supporting block 112 is disposed under the first rail 111 and supports the first rail 111. The first rail supporting block 112 may have a rectangular plate shape, however the shape of the first rail supporting block 112 is not limited thereto.

In an exemplary embodiment, the rear rail 120 is parallel with the front rail 110. The rear rail 120 is spaced apart from the front rail 110 by a predetermined space along the second direction, and supports a second side of the substrate B opposite the first side of the substrate B. The rear rail 120 includes a second rail 121 and a second rail supporting block 122. The second rail 121 may have a long plate shape extending in the first direction. The second rail 121 may be located at the same level as the substrate B. For example, the substrate B may be transferred along the rail member 100, and the second rail 121 may guide the second side of the substrate B. The second rail supporting block 122 is disposed under the second rail 121 and supports the second rail 121. The second rail supporting block 122 may have a rectangular plate shape, however the shape of the second rail supporting block 122 is not limited thereto. An opening 123 penetrates the second rail supporting block 122. The opening 123 may have a rectangular shape. A heating block 210 may pass through the opening 123 when a distance between the front rail 110 and the rear rail 120 is reduced. Thus, the opening 123 may have a width greater than a width of the heating block 210. The opening 123 may be disposed adjacent to the second rail 121.

The rail driver 130 may adjust a distance between the front rail 110 and the rear rail 120. For example, the rail driver 130 may adjust the distance between the front rail 110 and the rear rail 120 by moving at least one of the front rail 110 and the rear rail 120 in the second direction. In an exemplary embodiment, the rail driver 130 may adjust the distance between the front rail 110 and the rear rail 120 by moving the front rail 110 in the second direction. The adjusted distance between the front rail 110 and the rear rail 120 may correspond to a width (e.g., a distance along the second direction) of the substrate B. For example, if the substrate B corresponds to a first substrate having a first width, the distance between the front rail 110 and the rear rail 120 may be adjusted to have a first distance equal to the first width, permitting a wire bonding process to be performed on the first substrate. Alternatively, if the substrate B corresponds to a second substrate having a second width, the distance between the front rail 110 and the rear rail 120 may be adjusted to have a second distance equal to the second width, permitting a wire bonding process to be performed on the second substrate.

The heating member 200 may heat the substrate B to a predetermined temperature. Once the leads L and the semiconductor chips C disposed on the substrate B are heated to the predetermined temperature, the wire bonding process may be performed. The value of the predetermined temperature is based on the materials of the leads L of the lead frames and pads of the semiconductor chips C. For example, in an exemplary embodiment, the leads L of the lead frames and the pads of the semiconductor chips C may be pre-heated to a temperature of about 150° C. to about 250° C., and the wire bonding process may then be performed.

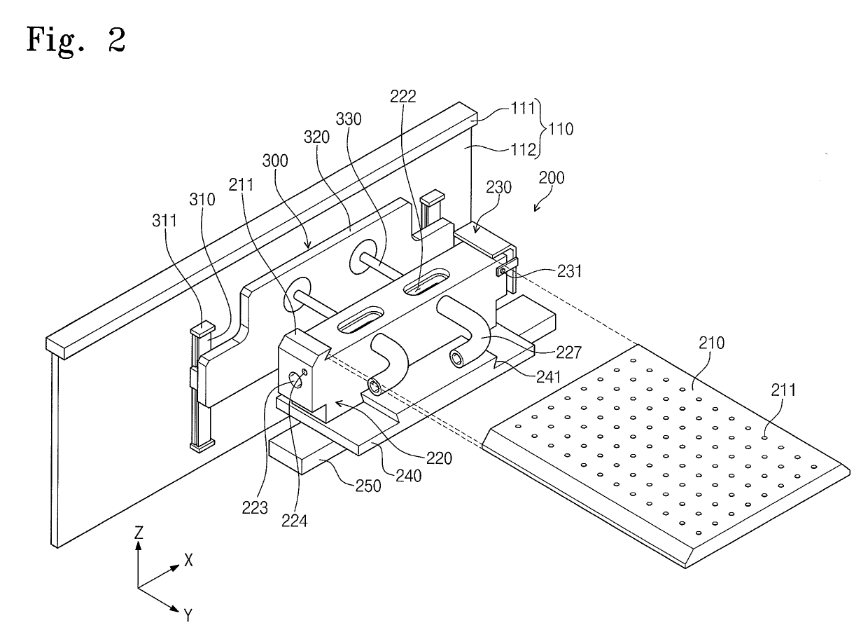

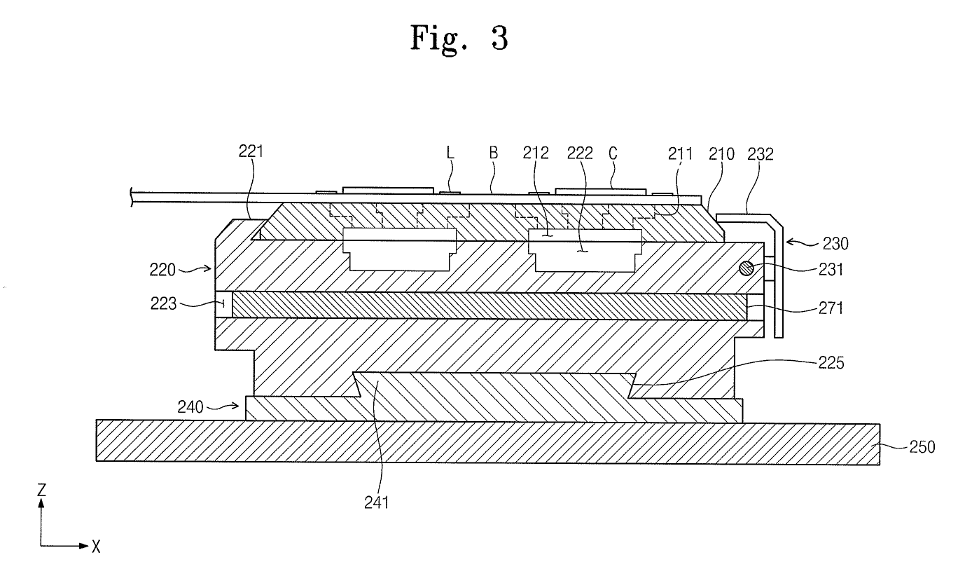

FIG. 2 is a perspective view illustrating a front rail and a heating member of FIG. 1, according to an exemplary embodiment. FIG. 3 is a vertical cross-sectional view taken along line A-A′ of FIG. 1, according to an exemplary embodiment.

Referring to FIGS. 2 and 3, the heating member 200 may include a heating block 210, a heating body 220, a clamping member 230, a guide block 240 and a supporting block 250.

The heating block 210 may have a rectangular plate shape, and a width in the second direction which is substantially equal to the width of the substrate B shown in FIG. 1. In an exemplary embodiment, vacuum holes 211 are arranged in the heating block 210 and are exposed at a top surface of the heating block 210. The vacuum holes 211 may be spaced apart from each other by a uniform distance. First vacuum grooves 212 are disposed at a bottom surface of the heating block 210, as shown in FIG. 3. In an exemplary embodiment, the number of the first vacuum grooves 212 may be two, and the first vacuum grooves 212 may be spaced apart from each other. The vacuum holes 211 may be spatially connected to the first vacuum grooves 212. Thus, if a vacuum pump connected to the vacuum grooves 212 is utilized, a pressure in the vacuum holes 211 may be equal to a pressure in the first vacuum grooves 212. The substrate B may be located on the heating block 210 during the wire bonding process. Heat generated by the heating body 220 may be conducted through the heating block 210 to the substrate B, thereby heating the substrate B. In an exemplary embodiment, a length (e.g., a distance along the first direction) of the substrate B is greater than a length of the heating block 210. Thus, the substrate B may sequentially move in the first direction by the length (e.g., a distance along the first direction) of the heating block 210 at least two times during the wire bonding process.

In an exemplary embodiment, the heating body 220 is disposed under the heating block 210 and supports the heating block 210. The heating body 220 may have a hexahedral shape and may extend in the first direction. A length (e.g., a distance along the first direction) of the heating body 220 may correspond to a length (e.g., a distance along the first direction) of the heating block 210. A fixed protrusion 221 may be disposed on one of the edges of the heating body 220. The fixed protrusion 221 may extend upward from an edge of the heating body 220, and an upper end of the fixed protrusion 221 may further extend toward a central portion of the heating body 220. Thus, an inner sidewall of the upper end of the fixed protrusion 221 may have a sloped profile, as illustrated in FIG. 3. Further, both edges of the heating block 210 may have a sloped profile, as shown in FIG. 3. Thus, one of the edges of the heating block 210 may be inserted into a space between the upper end of the fixed protrusion 221 and a top surface of the heating body 220, as shown in FIG. 3. As a result, the upper end of the fixed protrusion 221 may press down against one of the edges of the heating block 210, and the heating block 210 and the heating body 220 may be coupled.

In an exemplary embodiment, the clamping member 230 is installed at an edge of the heating body 220 that opposes the edge having the fixed protrusion 221, as shown in FIG. 3. The clamping member 230 may be rotatable on a pin 231 that penetrates the heating body 220 in the second direction. An upper end 232 of the clamping member 230 is substantially parallel with the top surface of the heating body 220. The upper end 232 of the clamping member 230 is disposed over the heating body 220 and spaced apart from the top surface of the heating body 220 by a predetermined distance. The opposing edge of the heating block 210 may be inserted into a space between the upper end 232 of the clamping member 230 and the top surface of the heating body 220, as shown in FIG. 3. The clamping member 230 may press down against the opposing edge of the heating block 210, and the heating block 210 and the heating body 220 may be coupled. Thus, in an exemplary embodiment, the heating block 210 and the heating body 220 may be coupled to each other by the fixed protrusion 221 and the clamping member 230.

In an exemplary embodiment, second vacuum grooves 222 are disposed at a top surface of the heating body 220. In an exemplary embodiment, the heating body 220 includes two second vacuum grooves 222, and the first vacuum grooves 212 are spaced apart from each other along the first direction. The second vacuum grooves 222 may have the same shape as the first vacuum grooves 212. The second vacuum grooves 222 may be disposed opposite the first vacuum grooves 212, respectively. Therefore, when the heating block 210 and the heating body 220 are coupled, the second vacuum grooves 222 may be spatially connected to respective ones of the first vacuum grooves 212. The second vacuum grooves 222 may be connected to a vacuum pump through vacuum lines 227. Thus, when the vacuum pump is utilized, pressure in the first and second vacuum grooves 212 and 222 and the vacuum holes 211 may be lowered, and the substrate B may be drawn to the heating block 210. That is, the substrate B may be temporarily fixed to the heating block 210 while the vacuum pump is utilized.

In an exemplary embodiment, a first insertion hole 223 and a second insertion hole 224 are disposed in the heating body 220. The first insertion hole 223 and the second insertion hole 224 may penetrate the heating body 220 in the first direction, as shown in FIG. 2. Thus, the first and second insertion holes 223 and 224 may correspond to through holes extending in the first direction and spaced apart from each other. The first insertion hole 223 may have a diameter greater than a diameter of the second insertion hole 224. In an exemplary embodiment, a heater 271 is disposed in the first insertion hole 223, as shown in FIG. 3. The heater 271 may heat the heating body 220. A thermocouple may be disposed in the second insertion hole 224. The thermocouple may detect and measure the temperature of the heating body 220.

The heating body 220 may be formed of a brass material having high thermal conductivity, however exemplary embodiments are not limited thereto. For example, the heating body 220 may be formed of any material having high thermal conductivity. As a result of the high thermal conductivity of the heating body 220, heat generated from the heater 271 is substantially uniformly conducted to all regions of the heating body 220, and the temperature variation in the heating body 220 can be minimized.

In an exemplary embodiment, a guide groove 225 is disposed at a bottom surface of the heating body 220. The guide groove 225 may extend in the second direction. A width (e.g., a distance along the first direction) of the guide groove 225 may be gradually reduced toward the bottom surface of the heating body 220, as shown in FIG. 3. That is, two opposing sidewalls of the guide groove 225 may have a sloped profile, and an upper width of the guide groove 225 may be greater than a bottom width of the guide groove 225.

In an exemplary embodiment, the guide block 240 is disposed under the heating body 220. The guide block 240 may have a rectangular shape when viewed from a plan view, and may be fixed to the supporting block 250. The supporting block 250 can move up and down with relation to the guide block 240. In an exemplary embodiment, the supporting block 250 moves only in the up and down directions, and is prohibited from moving horizontally. A guide protrusion 241 vertically extends from a portion of a top surface of the guide block 240 in the second direction. The guide protrusion 241 has a shape allowing it to be inserted into the guide groove 225. That is, the guide block 240 may be coupled with the heating body 220 by inserting the guide protrusion 241 into the guide groove 225. Thus, when the guide block 240 is coupled with the heating body 220, the heating body 220 may be moved along the second direction by the guide protrusion 241.

In an exemplary embodiment, the connecting member 300 connects the heating member 200 to the front rail 110, and includes a vertical guide rail 310, a vertical moving block 320 and a connection rod 330.

In an exemplary embodiment, the vertical guide rail 310 includes a pair of guide rails, and the pair of guide rails may be installed and fixed to an inner sidewall of the first rail supporting block 112. The pair of guide rails of the vertical guide rail 310 may be disposed in the third direction and may be spaced apart from each other in the first direction. Four cross bars 311 may be provided at upper and lower ends of the pair of guide rails, respectively. The cross bars 311 may prevent the vertical moving block 320 from moving away from the vertical guide rail 310.

The vertical moving block 320 may have a plate shape, and both sides of the vertical moving block 320 may be coupled with the pair of guide rails, respectively. Thus, the vertical moving block 320 may move up and down in the third direction.

In an exemplary embodiment, the connection rod 330 connects the vertical moving block 320 to the heating body 220. The connection rod 330 extends in the second direction. One end of the connection rod 330 is connected and fixed to the vertical moving block 320, and the other end of the connection rod 330 is connected and fixed to the heating body 220. In an exemplary embodiment, the connection rod 330 includes two rods extending in the second direction.

When the above-described configuration is utilized, the heating body 220 and the heating block 210 may be moved together with the front rail 110 in the second direction when the front rail 110 moves in the second direction. In this embodiment, the guide block 240 and the supporting block 250 remain stationary while the heating body 220 slides in the second direction. When the vertical moving block 320 moves up and down along the vertical guide rail 310, the heating block 210, the heating body 220, the guide block 240 and the supporting block 250 may move in the third direction.

While the substrate B is transferred to the heating member 200, the vertical moving block 320 may be moved down, and a top surface of the heating block 210 may be located at a level lower than the substrate B. Thus, the substrate B may be prevented from colliding with the heating block 210. If the substrate B is positioned over the heating block 210, the vertical moving block 320 may ascend, and the heating block 210 may be put into contact with the substrate B.

Referring again to FIG. 1, the wire bonding member 400 may be positioned at one side of the rail member 100. The wire bonding member 400 may connect the leads L of the lead frames and the pads of the semiconductor chips C, which are heated by the heating member 200, using bonding wires.

Hereinafter, a method of treating a substrate using the above-described exemplary embodiments of the apparatus will be described. According to exemplary embodiments, the substrate treatment method may include wire bonding processes performed on a first substrate and a second substrate having a different size from the first substrate. For example, a width (e.g., a distance along the second direction) of the first substrate may be different from a width (e.g., a distance along the second direction) of the second substrate. In this case, the substrate treatment method may include a first treatment process that includes treating the first substrate, and a second treatment process that includes treating the second substrate. The first and second treatment processes may be selectively performed according to the width of the substrate.

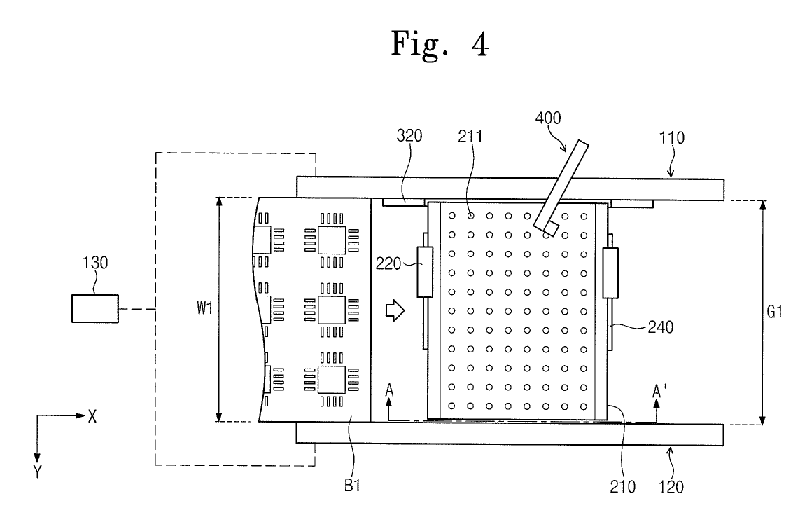

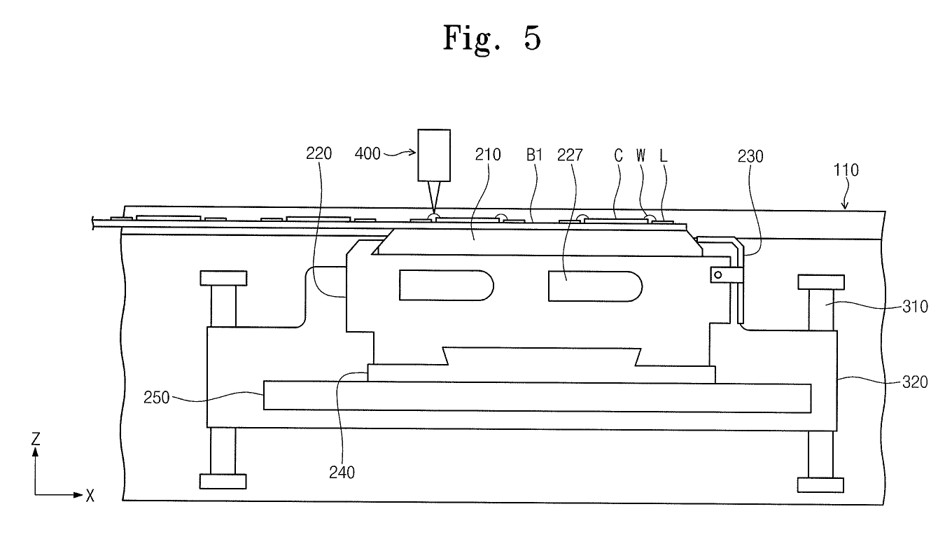

FIG. 4 is a plan view illustrating a method of treating a first substrate, according to an exemplary embodiment. FIG. 5 is a vertical cross-sectional view taken along line A-A′ of FIG. 4.

Referring to FIGS. 4 and 5, a wire bonding process may be performed on a first substrate B1. The first substrate B1 has a first width W1 extending in the second direction. In an exemplary embodiment, before the first substrate B1 is transferred along the rail member 100, the rail driver 130 may adjust a distance between the front rail 110 and the rear rail 120 to be substantially equal to a first distance G1. The rail driver 130 may move at least one of the front rail 110 and the rear rail 120 in the second direction to adjust the distance between the front rail 110 and the rear rail 120 to the first distance G1. For example, in an exemplary embodiment, the rail driver 130 may move the front rail 110 in the second direction to adjust the distance between the front rail 110 and the rear rail 120 to the first distance G1. The first distance G1 corresponds to the first width W1 of the first substrate B1. As a result, the heating block 210 may be disposed between the front rail 110 and the rear rail 120, which are separated from each other by the first distance G1. After the front rail 110 and the rear rail 120 are separated from each other by the first distance G1, the first substrate B1 may be transferred in the first direction along the front rail 110 and the rear rail 120. In this case, the heating block 210 may be located at a level lower than a transfer route of the first substrate B1. If a portion of the first substrate B1 is located over the heating block 210, the heating block 210 may move up to support the first substrate B1. The vacuum pump may then be utilized to lower the pressure in the vacuum holes 211. As a result, the first substrate B1 may be drawn to the heating block 210. That is, the first substrate B1 may be temporarily fixed to the heating block 210 while the vacuum pump is utilized.

In an exemplary embodiment, the heater 223 generates heat, and the heat generated from the heater 223 may be conducted through the heating block 210 to the first substrate B1. Once the leads L of the lead frames and the pads of the semiconductor chips C have been heated to a predetermined temperature, the wire bonding member 400 may connect the leads L and the pads using bonding wires. Once the wire bonding process has completed, and the semiconductor chips C and the lead frames on the heating block 210 are connected, the heating block 210 is moved down and the first substrate B1 is transferred in the first direction by a predetermined distance to sequentially line up the remaining semiconductor chips C and lead frames on the first substrate B1 over the heating block 210. Subsequently, the remaining semiconductor chips C and lead frames are connected by bonding wires using the same process.

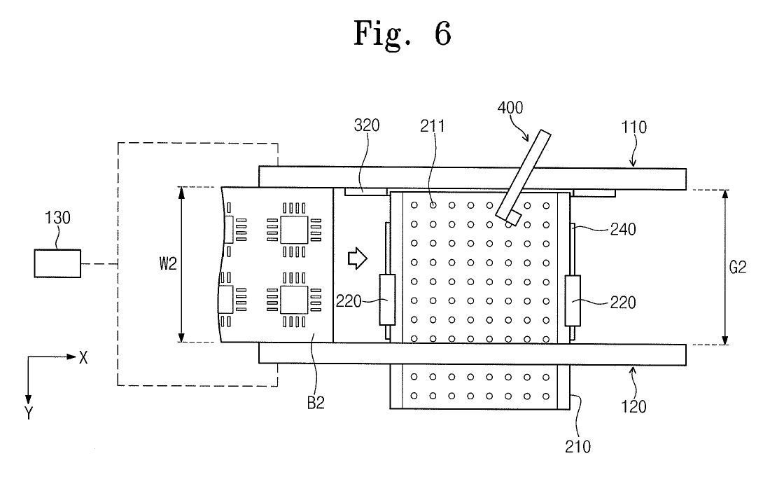

FIG. 6 is a plan view illustrating a method of treating a second substrate, according to an exemplary embodiment.

Referring to FIG. 6, a wire bonding process may be performed on a second substrate B2. The second substrate B2 has a second width W2 extending in the second direction. In an exemplary embodiment, before the second substrate B2 is transferred along the rail member 100, the rail driver 130 may adjust the distance between the front rail 110 and the rear rail 120 to be substantially equal to a second distance G2. The second distance G2 corresponds to the second width W2 of the second substrate B2. For example, in an exemplary embodiment, the rail driver 130 may move the front rail 110 in the second direction to adjust the distance between the front rail 110 and the rear rail 120 to the second distance G2. When the front rail 110 moves in the second direction, the heating body 220 and the heating block 210 may also be moved in the second direction. The heating body 220 may then slide along the guide block 240. If the second distance G2 is less than the first distance G1, an edge of the heating block 210 opposite the front rail 110 may pass through the opening 123, and may be located outside of the area between the front rail 110 and the rear rail 120, as shown in FIG. 6. That is, the rear rail 120 may overlap a portion of the heating block 210 when viewed from a top plan view. The second substrate B2 may be transferred along the front rail 110 and the rear rail 120 in the first direction. If the second substrate B2 is located over the heating block 210 when the heating block 210 moves up to support the second substrate B2, the vacuum pump may then be utilized to lower the pressure in the vacuum holes 211. As a result, the second substrate B2 may be drawn to the heating block 210. The second substrate B2 may then be heated, and the wire bonding process may be performed on the second substrate B2 using the process described with reference to FIGS. 4 and 5.

As described above, according to exemplary embodiments, first and second substrates B1 and B2 having different sizes may be heated using a single heating block. That is, in exemplary embodiments, the heating block does not have to be changed to perform a wire bonding process on substrates having different sizes.

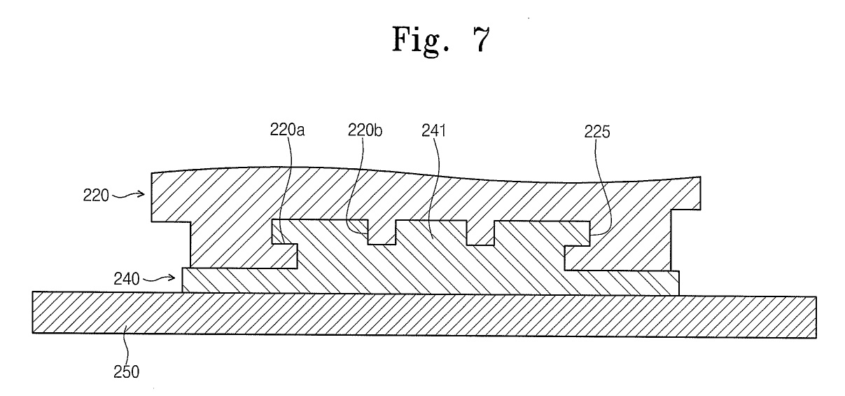

FIG. 7 is a cross-sectional view illustrating an apparatus including a heating member coupled with a guide block, according to an exemplary embodiment.

Referring to FIG. 7, a pair of first protrusions 220a and a pair of second protrusions 220b are disposed in the guide groove 225 formed at the bottom surface of the heating body 220. The pair of first protrusions 220a may horizontally protrude from both lower sidewalls of the guide groove 225 toward a central region of the heating body 220, respectively, as shown in FIG. 7. Thus, the pair of first protrusions 220a may be parallel with the top surface of the heating body 220. The pair of second protrusions 220b may vertically extend from a central region of the heating body 220 toward an inside region of the guide groove 225, as shown in FIG. 7. The pair of second protrusions 220b may be spaced apart from each other. The guide protrusion 241 of the guide block 240 has a shape that can be inserted into the guide groove 225 defined by the first and second protrusions 220a and 220b. The first and second protrusions 220a and 220b extend in the second direction. Thus, when the guide block 240 is coupled with the heating body 220, the heating body 220 may be moved along the second direction by the guide protrusion 241.

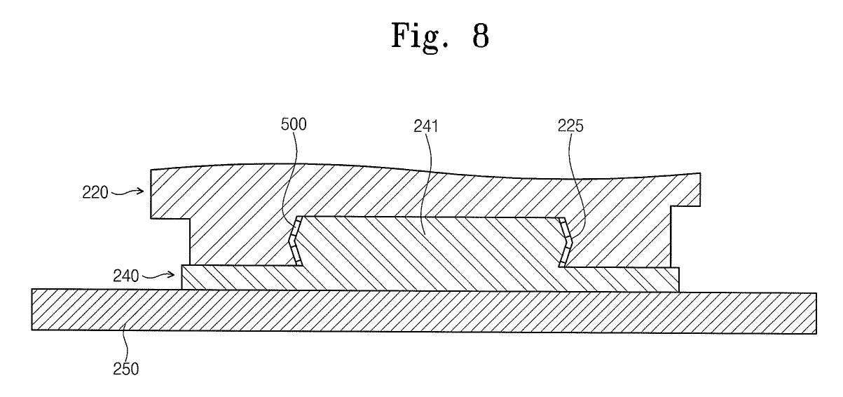

FIG. 8 is a cross-sectional view illustrating an apparatus including a heating member coupled with a guide block, according to an exemplary embodiment.

Referring to FIG. 8, the guide groove 225 may be defined by a first sidewall and a second sidewall opposite the first sidewall. In an exemplary embodiment, the first sidewall has a ‘<’-shaped configuration and the second sidewall has a ‘>’-shaped configuration when viewed from a vertical cross-sectional view, as illustrated in FIG. 8. The guide protrusion 241 of the guide block 240 has a shape that can be coupled with the guide groove 225 defined by the first and second sidewalls. V rails 500 are disposed between both the sidewalls defining the guide groove 225 and the sidewalls of the guide protrusion 241. The V rails 500 may be utilized to efficiently move the heating body 220 along the guide protrusion 241.

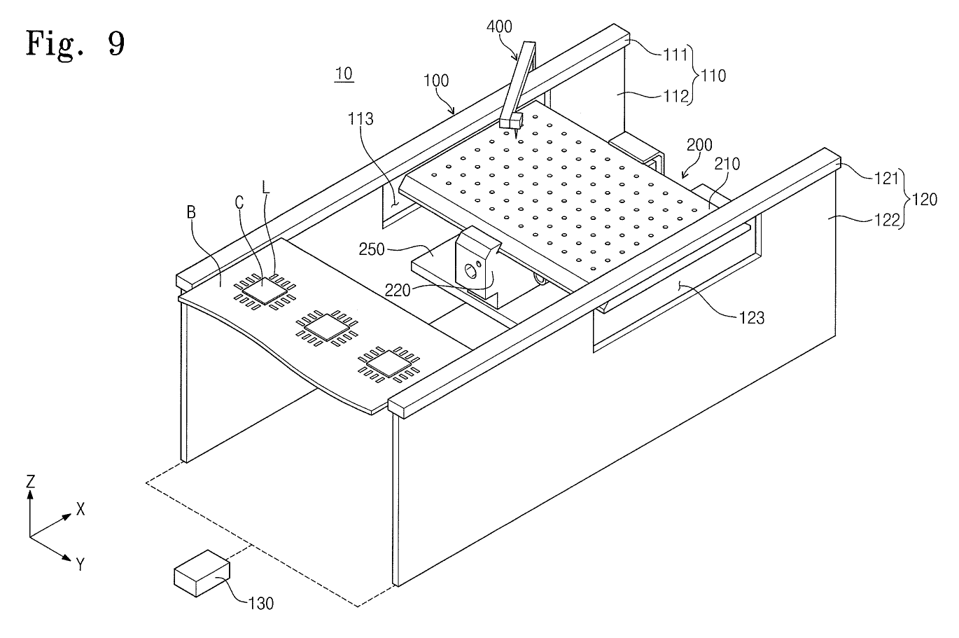

FIG. 9 is a perspective view illustrating an apparatus for treating a substrate, according to an exemplary embodiment.

Referring to FIG. 9, a first opening 113 penetrating the first rail supporting block 112 is formed in the front rail 110. The first opening 113 may have a rectangular shape, and may have a width greater than a width of the heating block 210. The first opening 113 may be adjacent to the first rail 111.

A second opening 123 penetrating the second rail supporting block 122 is formed in the rear rail 120. The second opening 123 has the same shape as the first opening 113, and is disposed opposite the first opening 113.

The rail driver 130 moves at least one of the front rail 110 and the rear rail 120 in the second direction to adjust the distance between the front rail 110 and the rear rail 120. For example, in an exemplary embodiment, the rail driver 130 may move both the front rail 110 and the rear rail 120 in the second direction.

The heating block 210 is fixed to the heating body 220, and the heating body 220 is fixed to the supporting block 250. The heating body 220 is disposed between the front rail 110 and the rear rail 120.

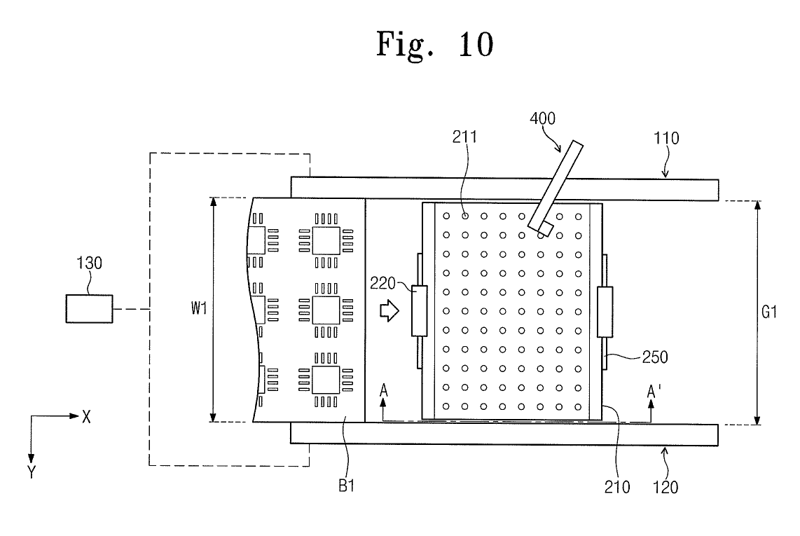

FIG. 10 is a plan view illustrating a method of treating a first substrate using the apparatus shown in FIG. 9, according to an exemplary embodiment.

Referring to FIG. 10, the rail driver 130 may move at least one of the front rail 110 and the rear rail 120 in the second direction to adjust the distance between the front rail 110 and the rear rail 120 to a first distance G1. The first distance G1 corresponds to a width W1 of a first substrate B1. The first substrate B1 may be transferred along the front rail 110 and the rear rail 120 in the first direction. Subsequently, pads of semiconductor chips and leads of lead frames disposed on the first substrate B1 may be connected to each other using the method described with reference to FIGS. 4 and 5.

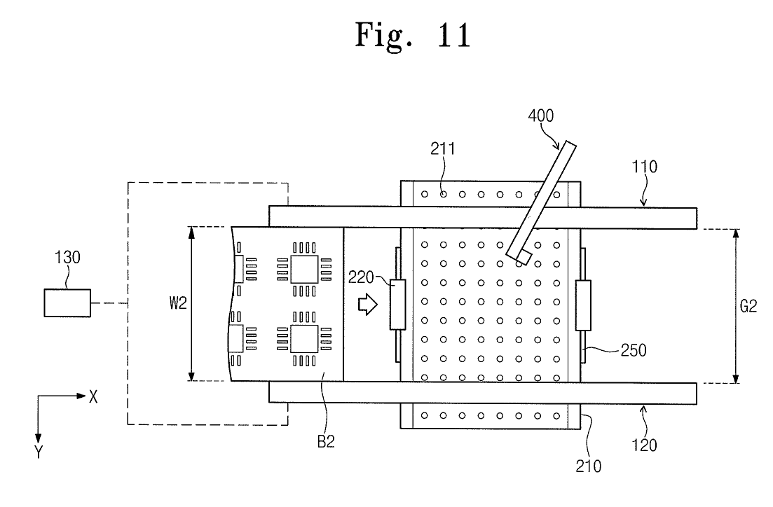

FIG. 11 is a plan view illustrating a method of treating a second substrate using the apparatus shown in FIG. 9, according to an exemplary embodiment.

Referring to FIG. 11, the rail driver 130 may move at least one of the front rail 110 and the rear rail 120 in the second direction to adjust the distance between the front rail 110 and the rear rail 120 to a second distance G2. The second distance G2 corresponds to a width W1 of a second substrate B2. The second distance G2 may be less than a width (e.g., a distance along the second direction) of the heating block 210. Thus, one edge of the heating block 210 may pass through the first opening 113 and may be located outside the space between the front rail 110 and the rear rail 120, and the other edge of the heating block 210 may pass through the second opening 123 and may be located outside the space between the front rail 110 and the rear rail 120, as shown in FIG. 11. The heating block 210 is disposed between the front rail 110 and the rear rail 120. The second substrate B2 may be transferred along the front rail 110 and the rear rail 120 in the first direction. Subsequently, pads of semiconductor chips and leads of lead frames disposed on the second substrate B2 may be connected to each other using the method described with reference to FIG. 6.

As described above, in exemplary embodiments, at least one of the front rail 110 and the rear rail 120 may be moved to adjust an effective width of the heating block 210 between the front rail 110 and the rear rail 120. As a result, a wire bonding process may be performed on first and second substrates B1 and B2 having different sizes using the single heating block 210.

According to the exemplary embodiments described above, a plurality of substrates having different sizes from each other may be treated using a single heating block.

While the inventive concept has been particularly shown and described with reference to the exemplary embodiments thereof, it will be understood by those of ordinary skill in the art that various changes in form and detail may be made therein without departing from the spirit and scope of the inventive concept as defined by the following claims.

What is claimed is:

1. An apparatus for treating a substrate, comprising:
a heating member comprising a heating block, wherein the heating block is configured to receive and heat the substrate;
a front rail disposed at a first side of the heating block, and configured to support a first edge of the substrate;
a rear rail disposed at a second side of the heating block, opposing the first side, wherein the rear rail is substantially parallel with the front rail and is configured to support a second edge of the substrate; and
a rail driver configured to move at least one of the front rail and the rear rail, wherein a distance between the front rail and the rear rail is adjusted to be substantially equal to a width of the substrate.

2. The apparatus of claim 1, further comprising:
a connecting member fixedly connecting the heating member and the front rail,
wherein the heating member is configured to move with the front rail.

3. The apparatus of claim 2, wherein the heating block is disposed in an area between the front rail and the rear rail upon adjusting the distance between the front rail and the rear rail to be a first distance, and a portion of the heating block is disposed outside the area between the front rail and the rear rail upon adjusting the distance between the front rail and the rear rail to be a second distance,
wherein the second distance is less than the first distance.

4. The apparatus of claim 3, wherein a width of the heating block is substantially equal to the first distance.

5. The apparatus of claim 3, wherein the rear rail comprises:
a rail disposed substantially at a same level as the substrate; and
a rail supporting block disposed under the rail and configured to support the rail,
wherein the rail supporting block comprises an opening shaped and dimensioned to permit an edge of the heating block to pass through the opening upon moving the front rail.

6. The apparatus of claim 2, wherein the heating member further comprises:
a supporting block disposed under the heating block, wherein the supporting block is fixed in a horizontal direction; and
a heating body disposed between the heating block and the supporting block, and configured to support and heat the heating block,
wherein the heating body is coupled with the supporting block, the heating body is configured to move in the horizontal direction, and the connecting member connects the heating body and the front rail.

7. The apparatus of claim 6, further comprising:
a guide protrusion disposed on a top surface of the supporting block; and
a guide groove formed at a bottom surface of the heating body,
wherein the supporting block and the heating body are coupled with each other via the guide protrusion and the guide groove, and the heating body is configured to slide along the guide protrusion.

8. The apparatus of claim 6, wherein the front rail comprises:
a rail disposed substantially at a same level as the substrate; and
a rail supporting block disposed under the rail and configured to support the rail.

9. The apparatus of claim 8, wherein the connecting member comprises:
a vertical guide rail fixedly connected to the rail supporting block;
a vertical moving block configured to move along the vertical guide rail in a vertical direction; and
a connection rod connecting the heating body and the vertical moving block.

10. The apparatus of claim 6, wherein the heating body is formed of a brass material.

11. A method of treating a first substrate and a second substrate, comprising:
adjusting a distance between a front rail of an apparatus and a rear rail of the apparatus to be substantially equal to a width of the first substrate;
transferring the first substrate into a space between the front rail and the rear rail while the distance is substantially equal to the width of the first substrate;
heating the first substrate while the first substrate is in the space;
adjusting the distance to be substantially equal to a width of the second substrate;
transferring the second substrate into the space while the distance is substantially equal to the width of the second substrate; and
heating the second substrate while the second substrate is in the space,
wherein the width of the second substrate is less than the width of the first substrate, and the front rail and the rear rail are substantially parallel with each other.

12. The method of claim 11, wherein adjusting the distance between the front rail and the rear rail comprises moving at least one of the front rail and the rear rail.

13. The method of claim 11, wherein the first and second substrates are heated using a heating block of the apparatus.

14. The method of claim 13, wherein the heating block is disposed in the space between the front rail and the rear rail while the first substrate is in the space, and a portion of the heating block is disposed outside the space while the second substrate is in the space.

15. The method of claim 13, wherein adjusting the distance between the front rail and the rear rail comprises moving the front rail, and the heating block is configured to move with the front rail.

16. The method of claim 15, wherein an edge of the heating block passes through an opening disposed in the rear rail and is located outside the space between the front rail and the rear rail while the second substrate is in the space.

17. The method of claim 15, further comprising:
sliding a heating body and the front rail in a horizontal direction along a guide block,
wherein the heating body comprises a heater, the heating block is coupled with the heating body, the heating body is coupled with the guide block, and the guide block is fixed in the horizontal direction.

18. A method of treating a substrate, comprising:
adjusting a distance between a front rail of an apparatus and a rear rail of the apparatus to be substantially equal to a width of the substrate;
transferring the substrate into a space between the front rail and the rear rail; and
heating the substrate using a heating block of the apparatus,
wherein the front rail and the rear rail are substantially parallel with each other, and an edge of the heating block is permitted to pass through an opening disposed in at least one of the front rail and the rear rail while the distance is adjusted.

19. The method of claim 18, wherein adjusting the distance between the front rail and the rear rail comprises moving at least one of the front rail and the rear rail.

20. The method of claim 18, wherein adjusting the distance between the front rail and the rear rail comprises moving the front rail, and the heating block is moved with the front rail.
